(19) United States
(12) Patent Application Publication
(10) Pub. No.: US 2009/0217119 A1
(43) Pub. Date: Aug. 27, 2009

(54) METHOD, SYSTEM AND RELAY STATION FOR REALIZING HYBRID AUTOMATIC RETRANSMISSION

(75) Inventors: Aimin ZHANG, Shenzhen (CN); Zheng SHANG, Shenzhen (CN); Yuanyuan WANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/341,621

(22) Filed: Dec. 22, 2008

Related U.S. Application Data
(63) Continuation of application No. PCT/CN2007/070163, filed on Jun. 22, 2007.

(30) Foreign Application Priority Data
Jun. 22, 2006 (CN) 200610090037.3

(51) Int. Cl. H04L 1/18; H04W 84/02

(52) U.S. Cl. 714/748; 370/338

(57) ABSTRACT

A method for implementing hybrid automatic retransmission is provided in a communication system. In the method, a terminal transmits a data block to a receiving side through a relay station; the relay station returns a receiving status of the relay station to the receiving side; and the transmitting side determines whether retransmission of the data block is needed according to the receiving status. A system for implementing hybrid automatic retransmission and a relay station are described, also. Accordingly, the system performance is enhanced, the transmission quality is improved. In addition, the relay station is transparent to the terminal such that no modification is required to be made to the existing terminal in the system having a relay station.

### CROSS-REFERENCE TO RELATED APPLICATIONS

This application is a continuation of International Patent Application No. PCT/CN2007/070163, filed Jun. 22, 2007, which claims priority to Chinese Patent Application No. 200610090037.3, filed Jun. 22, 2006, both of which are hereby incorporated by reference in their entirety.

### FIELD OF THE INVENTION

The present invention relates to hybrid automatic retransmission (HARQ) technique, more specifically, to a method, system, and relay station for implementing HARQ.

### BACKGROUND

World Interoperability for Microwave Access (WiMAX) is a Broadband Wireless Access (BWA) technique, with its air interface based on IEEE 802.16 protocol. The WiMAX system deploys Orthogonal Frequency Division Multiple Address (OFDMA) as one of its multiple address techniques for it unique advantage. FIG. 1 illustrates a physical frame structure in Time Division Duplex (TDD) mode based on OFDMA specified in the 802.16 protocol. The WiMAX system utilizes such frame structure, in which (a) refers to a base station frame, (b) refers to a terminal frame, the part with oblique lines refers to transmission status, and the clean part refers to receiving status. The base station frame is constituted by a downlink sub-frame and an uplink sub-frame. The downlink sub-frame is used to send the downlink data and the uplink sub-frame is used to receive the uplink data. TTG refers to the time interval for the base station to transit from the transmission status to the receiving status, and RTG refers to the time interval for transition from the receiving status to the transmission status. The SSRTG refers to the time interval for the terminal to transit from the receiving status to the transmission status and the SSTTG refers to the time interval for the terminal to transit from the transmission status to the receiving status. Logic sub-channel refers to the sequence number for the sub-channel in logic order. One sub-channel is comprised of several sub-carriers. The terminal synchronization sequence is used for the terminal to search network and to synchronize with the base station. The terminal frame header is used to indicate the information of time and frequency resource allocation. By decoding the received frame header information, the terminal is able to know where it receives the data from and where it sends the data to. The base station transmits data via the downlink sub-frame and receives data via the uplink sub-frame, while the terminal receives data via the downlink sub-frame and transmits data via the uplink sub-frame. The terminal frame header indicates where each terminal receives the data and transmits the data.

The WiMAX system employs an HARQ technique, a feedback-retransmission mechanism for underlying layer, which may perform retransmission in the physical layer. The transmitting side adds a cyclic redundancy check (CRC) data to the data block to be transmitted. After the data block is transmitted, the receiving side decodes the data block. Then, the receiving side performs CRC calculation on the data block and determines if the data block has been received correctly, by virtue of the calculation result. The receiving side may feed back a receiving status to the transmitting side at a specified time. The transmitting side may retransmit the data block, according to the feedback information from the receiving side. The receiving side may combine the retransmitted data block with the previously received data blocks at the physical layer and achieve diversity gain. Therefore, after the data is retransmitted because of error, it may be provided, at the same time, with the power gain and diversity gain, which may counter the channel fading effectively. The HARQ is a stop and wait protocol, which means that after the transmitting side has transmitted a data block, the receiving side must feed back the receiving status for the data block, after a fixed time delay.

According to 802.16 protocol, for the downlink HARQ data block transmitted from the base station to the terminal, the corresponding terminal must send feedback to the base station in the HARQ feedback area of a specified frame. The HARQ feedback area includes several HARQ feedback sub-channels. The sub-channel that the terminal uses to transmit the feedback needs to be associated with the sequence number of the downlink HARQ data block. As illustrated in FIG. 2, the ellipses with oblique lines denote HARQ data blocks, and the squares with oblique lines designated by 0, 1, and 2 refers to HARQ feedback. In the figure, at the downlink sub-frame of the i^{th} frame, the base station transmits HARQ data blocks 0, 1, and 2 to the terminal. With j frames passed, i.e., i+j^{th} frame, at the sub-channel associated with the HARQ feedback area in the uplink sub-frame, the terminal transmits feedback 0, 1, and 2, which is ACK (acknowledge) or NAK (non-acknowledge), indicating whether the data block has been received correctly.

For the uplink HARQ data transmitted from the terminal to the base station, the base station sends HARQ feedback message at a specified frame. The message is a broadcast message including a bitmap. Each bit of the bitmap represents a transmission status for a corresponding uplink HARQ data block. By receiving the broadcast message, the terminal may learn if the uplink HARQ data block transmitted by the terminal has been received correctly by the base station, according to the corresponding bit of the bitmap. FIG. 3 illustrates the transmission and feedback of uplink HARQ where the ellipse with oblique lines refers to HARQ data block and the grid-filled part refers to the HARQ feedback message. Several terminals transmit uplink HARQ data blocks 0, 1, and 2 to the base station at the uplink sub-frame of the i^{th} frame. With j frames passed, i.e. at i+j^{th} frame, the base station transmits a HARQ feedback message. The terminals decode the feedback message so as to determine if the uplink HARQ data blocks that they transmit have been received by the base station correctly. The HARQ feedback message includes following two fields: bitmap length and bitmap field, where bitmap length indicates the number of bytes that the bitmap takes up, and the k^{th} bit of the bitmap indicates the receiving status of the k^{th} uplink HARQ data block.

In wireless communication system, due to path fading of the electromagnetic waves or the block of the building, etc., the signal strength of the wireless communication signals in some places is relatively weak, leading to a poor communication quality for the mobile station in these places. With the growing demands for the broadband wireless communication, there are increasing needs for wireless bandwidth. As a result, higher and higher carrier frequencies are utilized in the new protocol and system. However, since the significance of fading of the wireless electric wave increases with the frequency, a high carrier frequency is bound to face with the problem of a significant fading, which may further restrain the coverage of the base station. In order to solve the coverage problem for the base station, a relay station is typically employed to strengthen the wireless communication signal between a base station and a mobile station. No wire is needed between the relay station and base station, rather, they communicate through wireless link. Advantageously, the convenience and the low cost for network arrangement is expected. FIG. 4 illustrates a wireless communication system having a relay station. The relay station, which is located within the coverage of the base station, provides relay service for the terminal beyond the coverage of the base station. In FIG. 4, the base station may not be able to cover mobile station 2 and mobile station 3 directly, but may accomplish the coverage with the help of relay station 1 and relay station 2.

However, the 802.16 protocol provides no teaching as for how HARQ is achieved between the base station and terminal, when the relay station is introduced.

### SUMMARY

One object of the embodiments of the present invention is to provide a method for implementing HARQ in a communication system with a relay station. The method may be used for implementation of HARQ in a communication system in TDD mode based on OFDMA, when a relay station is introduced in the communication system.

A second object of the embodiments of the present invention is to provide a system for implementing HARQ. The system is used to implement HARQ, according to the receiving status of the data block.

A third object of the embodiments of the present invention is to provide a relay station for implementing HARQ. The relay station is used to relay the data blocks between the base station and the terminal, and set and transmit the receiving status of the data block.

To these ends, a method for implementing hybrid automatic retransmission in a communication system with a relay station is provided, according to one embodiment of the present invention. The method includes: transmitting, by the base station, the data block to be transmitted to the terminal to the relay station, via a relay downlink sub-frame, wherein the relay station serves the terminal; relaying, by the relay station, the data block to the terminal via a terminal downlink sub-frame in a time and frequency resource allocated to the terminal by the base station, after the relay station receives the data block; decoding and verifying, by the terminal, the received data block, and transmitting feedback information in a hybrid automatic retransmission feedback sub-channel based on the result of the verification; transmitting, by the relay station, new feedback information to the base station, according to the feedback information transmitted from the terminal and status information of the relay station receiving the data block from the base station; and decoding, by the base station, the new feedback information and controlling retransmission procedure, according to the new feedback information.

There is provided a method for implementing hybrid automatic retransmission, including: receiving, by a relay station, a data block transmitted in an uplink time and frequency resource allocated to a terminal by a base station, from the terminal; transmitting, by the relay station, a receiving status message of the relay station indicating whether the data block is correctly received by the relay station, to the base station; transmitting, by the base station, the content of the receiving status message of the relay station to the terminal; and controlling, by the base station, the terminal or the relay station to retransmit the data block, according to the receiving status message of the relay station.

There is further provided a system for implementing hybrid automatic retransmission, according to one embodiment of the present invention. The system includes: a relay station and a base station, wherein: the relay station is configured to receive a data block transmitted from the terminal and send receiving status information of the relay station to the base station, wherein the receiving status information of the relay station indicates whether the relay station receives the data block correctly; the base station is configured to determine whether the data block needs to be retransmitted, according to the status information of the relay station receiving the data block.

There is further provided a replay station, according to an embodiment of the present invention. The relay station includes: means for receiving, from a terminal, a data block in an uplink time and frequency resource allocated to a terminal by a base station; means for sending receiving status information of the relay station to the base station, wherein the receiving status information of the relay station indicates whether the relay station receives the data block correctly; and means for retransmitting the data block to the base station, if the base station determines that the data block is received by the relay station correctly, according to the receiving status information of the relay station, but is received by the base station incorrectly.

A physical frame structure in TDD and OFDMA mode is utilized in embodiments of the present invention. The relay station relays the data block transmitted from the terminal or the base station to the receiving side. The relay station feeds back a receiving status of the data block to the transmitting side, after completing the transmission. The transmitting side decides whether a retransmission of the data block is needed, based on the receiving status, and decides whether to retransmit at the relay station or at the transmitting side. As such, the hybrid automatic retransmission is realized in a communication system having a relay station, the system performance is enhanced, and the transmission quality is improved. These embodiments of the present invention utilize the negotiation between the base station and the relay station to retransmit data without the involvement of the terminal. The terminal is completely unconscious of the data transmission status between the base station and the relay station. As a result, the transparency of the relay station for the terminal is achieved. Therefore, in a system with a relay station, no modification needs to be made to the existing terminal, thereby providing the compatibility for the conventional terminal.

### BRIEF DESCRIPTION OF THE DRAWINGS

FIG. 1 is a physical frame structure in TDD mode, based on OFDMA, according to 802.16 protocol;

FIG. 2 is a diagram of HARQ feedback area;

FIG. 3 is a diagram of transmission and feedback of uplink HARQ;

FIG. 4 is a diagram of a wireless communication system having a relay station;

FIG. 5 is physical frame structures of a base station, a relay station, and a terminal, according to one embodiment of the present invention;

FIG. 6 is another physical frame structures of a base station, a relay station, and a terminal, according to one embodiment of the present invention;

FIG. 7 is a flowchart for relaying downlink HARQ data block through a relay station, according to one embodiment of the present invention;

FIG. 8 is a diagram illustrating a format of a feedback message sent from the relay station to the base station, according to one embodiment of the present invention;

FIG. 9 is a diagram illustrating the encoding of the downlink HARQ data block status, according to one embodiment of the present invention;

FIG. 10 is a flowchart for relaying uplink HARQ data block through a relay station, according to one embodiment of the present invention;

FIG. 11 is a diagram illustrating a format of a receiving status message regarding the uplink HARQ data block, according to one embodiment of the present invention;

FIG. 12 is a diagram of a system for implementing HARQ, according to one embodiment of the present invention; and

FIG. 13 is a diagram of a relay station, according to one embodiment of the present invention.

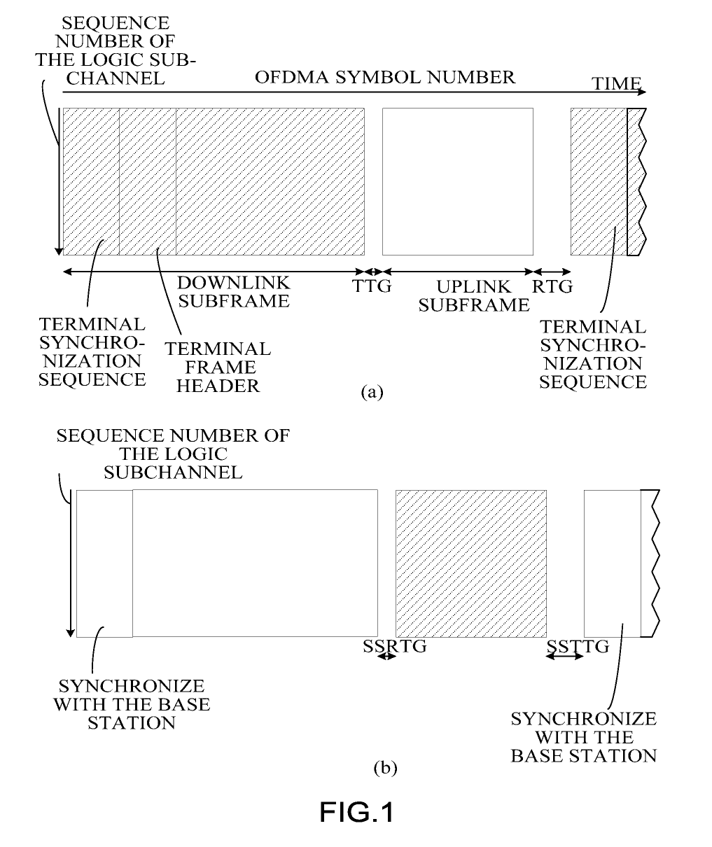

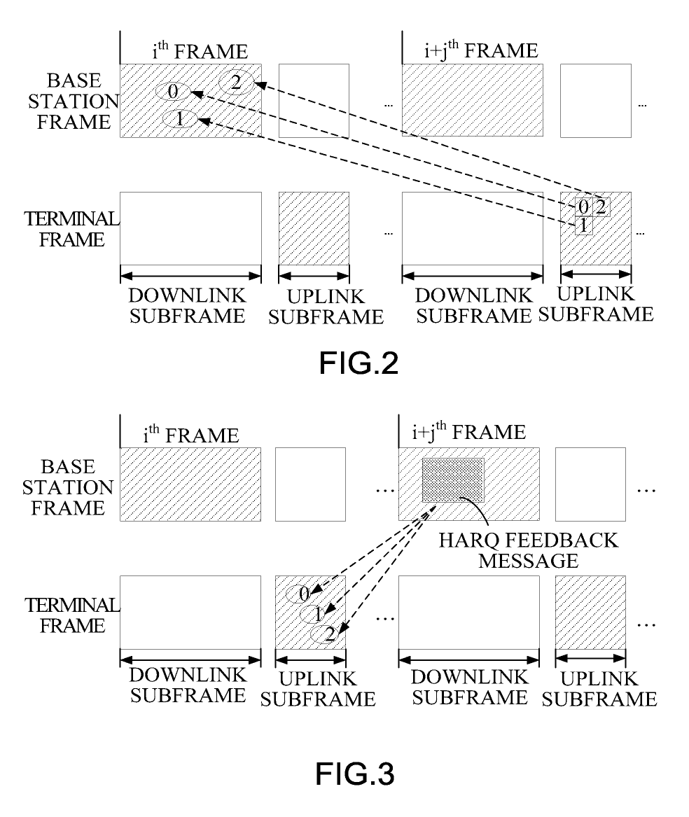

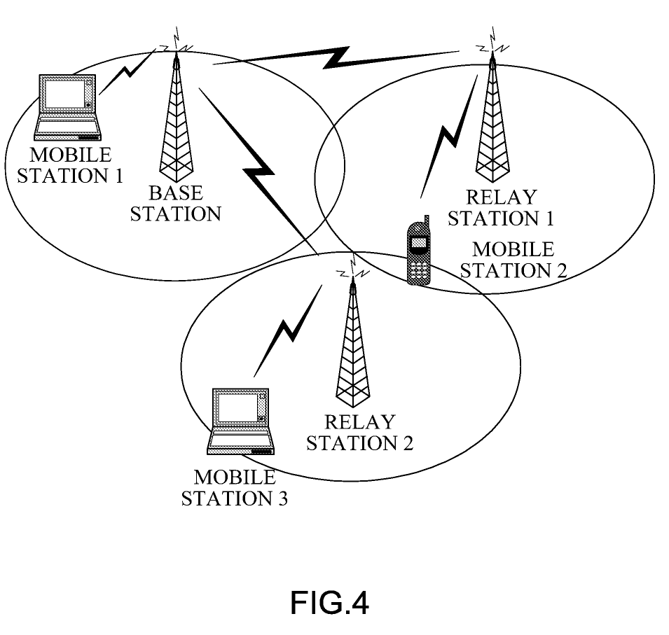

### DETAILED DESCRIPTION

According to embodiments of the present invention, a HARQ process is implemented when a relay station is introduced in a communication system, which utilizes the Time Division Duplex (TDD) and OFDMA according to a protocol, for example, 802.16.

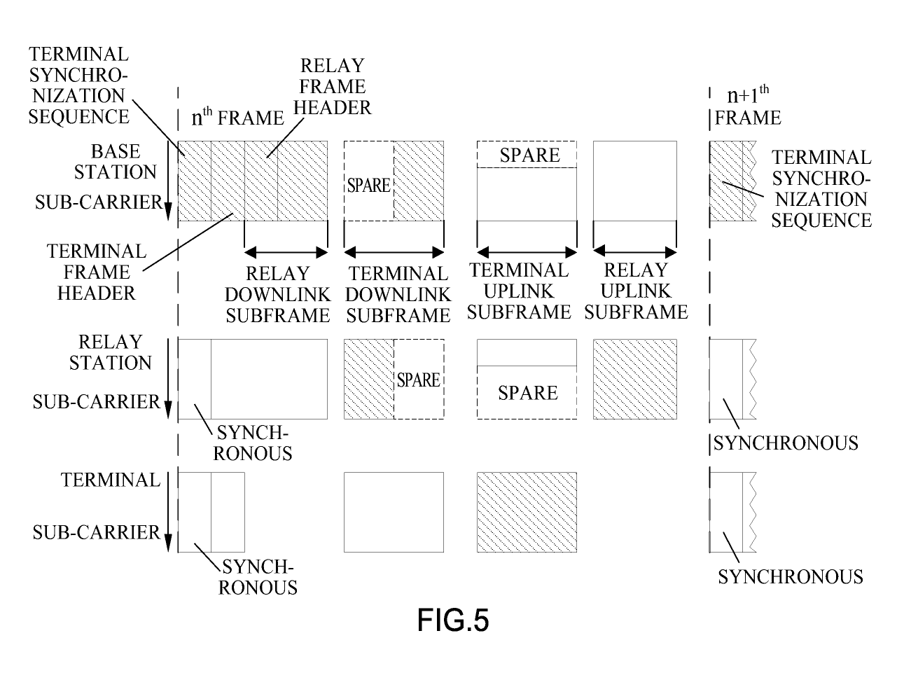

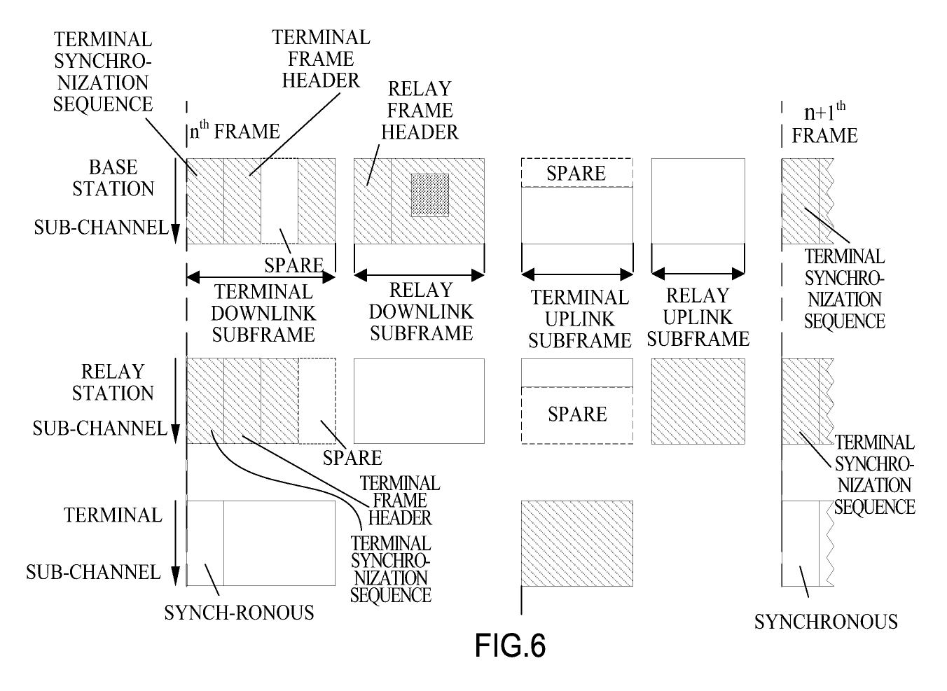

After the relay station is introduced, the physical frame structures of the base station, the relay station and the terminal are illustrated in FIG. 5 and FIG. 6 as examples, in which the part with oblique lines refers to transmission status, the clean part refers to receiving status, the dashed block refers to spare status, and the part with grids refers to a next terminal frame header. The base station frame includes four parts: a terminal downlink sub-frame, a relay downlink sub-frame, a terminal uplink sub-frame, and a relay uplink sub-frame. The terminal downlink sub-frame and the terminal uplink sub-frame are used to provide service for the terminals within the area covered by the base station. The relay downlink sub-frame and the relay uplink sub-frame are used to provide service for relay station that is covered by the base station. Corresponding to the base station frame, the relay station frame also includes four parts. A terminal downlink sub-frame and a terminal uplink sub-frame are used to provide service for the terminals within the coverage of the relay station. The relay downlink sub-frame is used to receive the data from the base station, while the relay uplink sub-frame is used to send data to the base station. The relay station acquires time and frequency resource allocation information of the relay downlink sub-frame and the relay uplink sub-frame by receiving the relay frame header. The terminal synchronizes with the base station or the relay station by using the terminal synchronization sequence. The terminal acquires its time and frequency resource allocation information by receiving a terminal frame header. The terminal frame header only provides the time and frequency resource allocation information of the terminal downlink sub-frame and the terminal uplink sub-frame. Therefore, the data is received by the terminal only in the terminal downlink sub-frame, and the data is transmitted by the terminal only in the terminal uplink sub-frame. The terminal does not operate during the time slots of the relay downlink sub-frame and the relay uplink sub-frame. The spare areas in FIG. 5 are used simply to indicate that the relay station and the base station use time and frequency resources in an orthogonal manner. Virtually, the time and frequency resources can be divided arbitrarily as long as the orthogonality is ensured.

The common characteristic shared by two types of frame structures as illustrated FIG. 5 and FIG. 6 is that the time and frequency resource allocation of the terminal downlink sub-frame and the terminal uplink sub-frame of the base station and the relay station is given by the terminal frame header. Even in the frame structure illustrated in FIG. 6, although the relay station also transmits a terminal frame header, the information transmitted by the relay station is identical with that of the base station. That is to say, the terminal frame header to be transmitted by the relay station has to be provided by the base station in a previous frame. The purpose of doing so is to ensure the transparency of the relay station for the terminal. The terminal frame header received by the terminal is the addition of the signals transmitted from the base station and the relay station. However, the terminal may not notice the existence of the relay station.

The difference between the frame structure illustrated in FIG. 5 and the frame structure illustrated in FIG. 6 is that, the relay station does not transmit the terminal synchronization sequence and the terminal frame header in the frame structure illustrated in FIG. 5, while the relay station transmits the terminal synchronization sequence and the terminal frame header in the frame structure illustrated in FIG. 6.

In the terminal downlink sub-frame, when the terminal is in a receiving status, the relay station is in a transmission status. In the terminal uplink sub-frame, when the terminal is in a transmission status, the relay station is in a receiving status.

In one embodiment of the present invention, the terminal or the base station relays the data block to the receiving side via the relay station. The relay station feeds back the receiving status of the data block to the transmitting side, after completing the transmission. According to the receiving status, the transmitting side determines whether the data block needs to be retransmitted and whether to retransmit the data block at the relay station or at the receiving side. As such, the HARQ is achieved in the communication system having the relay station. Here, the base station or the terminal transmitting the data block may be called the transmitting side, and the destination side which receives the data block may be called the receiving side.

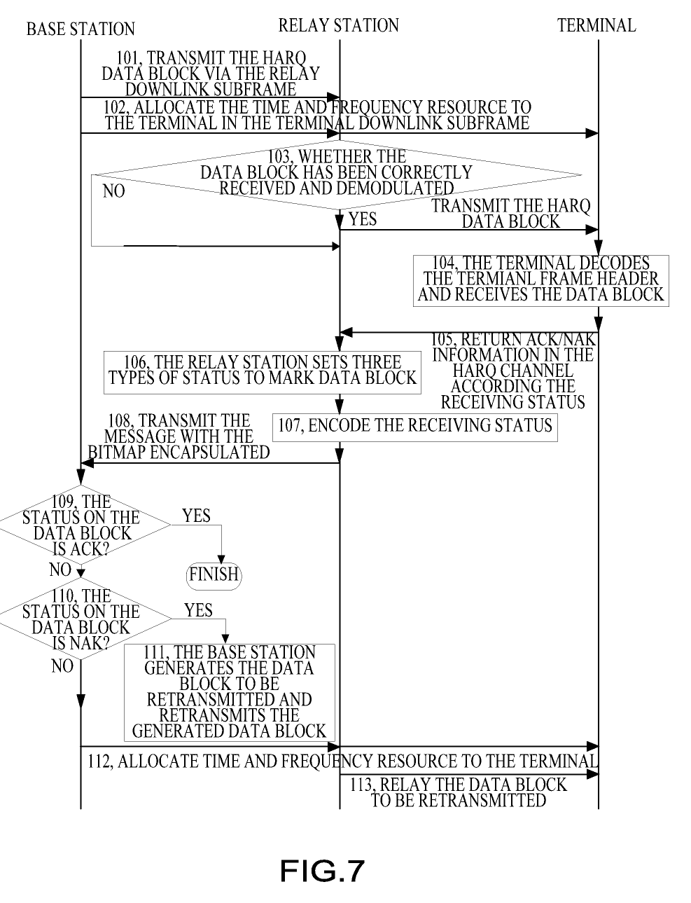

FIG. 7 is a flowchart of a method for relaying downlink HARQ data block through a relay station, according to one embodiment of the present invention. The method may include the following steps.

At Step 101, the base station transmits, via the relay downlink sub-frame, the HARQ data block to be transmitted to the terminal to the relay station which serves the terminal.

At Step 102, the base station allocates the time and frequency resource to the terminal in the terminal frame header. The time and frequency resource is used by the relay station for the transmission of data block. The base station may inform the terminal of the parameters regarding the data block. The parameters may include the type of HARQ, the sequence number, and the modulation scheme of the data block. The terminal may directly receive the messages relating to the time and frequency resource and parameters regarding the HARQ data block transmitted from the base station or relayed by the relay station.

At Step 103, the relay station determines if the HARQ data block has been correctly received and demodulated. If so, the relay station transmits the data block via the terminal downlink sub-frame in the time and frequency resources allocated by the base station. Otherwise, the relay station may not transmit the data block.

At Step 104, the terminal decodes the terminal frame header and receives the data block in the allocated time and frequency resources.

At Step 105, the terminal decodes and verifies the received HARQ data block according to the information of the parameters, and determines whether the data block passes the verification. If the data block passes the verification, the terminal may feed back acknowledge (ACK) information in a HARQ sub-channel; otherwise, the terminal may feed back non-acknowledge (NAK) information.

If the HARQ data block is the retransmitted data, the terminal needs to combine the retransmitted data with the cached data to obtain the diversity gain prior to decoding.

At Step 106, the relay station sets three types of receiving status to mark the data block according to the feedback information received from the terminal and receiving status information of the relay station. The three types of receiving status of the HARQ data block may be: an ACK, which indicates that the data block has been received by the terminal correctly; a NAK, which indicates that the data block has not been received by the relay station correctly; and a RACK, which indicates that the data block has been received by the relay station correctly, but has not been received by the terminal correctly.

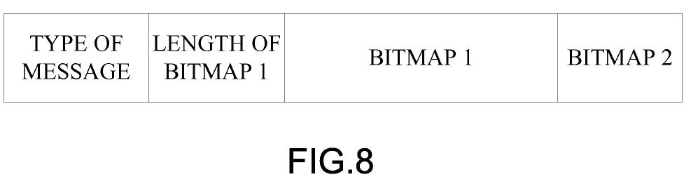

At Step 107, the bitmap scheme is utilized for encoding of the receiving status of the HARQ data block. Suppose that there are three types of receiving status of the data block, two bits are typically needed to encode the statuses. In the instance, the more the feedback information is transmitted, the more bandwidth is needed. One embodiment of the present invention employs a two-stage encoding scheme, which may reduce the size of feedback information. FIG. 8 illustrates the format of the message which the relay station feeds back to the base station. Referring to FIG. 8, the message type field is used to identify the message type so as to distinguish the message from other messages. Bitmap 1 length field represents the length of bitmap 1. The unit of the length may be byte or bit. The bitmap 1 field is used for feedback of the receiving status of the terminal receiving the HARQ data block, i.e. ACK or NAK. The k^{th} bit of the bitmap represents the receiving status of the terminal receiving the k^{th} HARQ data block relayed by the relay station. For instance, binary “1” represents ACK, binary “0” represents NAK, or vice versa. If the binary “1” indicates receiving correctly and the binary “0” indicates receiving incorrectly, the value of the k^{th} bit of the bitmap is equal to a bitwise “AND” operation on the status of the k^{th} HARQ data block received by the relay station from the base station and the feedback status after the terminal receives the data block. If the binary “1” indicates receiving incorrectly, and the binary “0” indicates receiving correctly, the value is equal to a bitwise “OR” operation on the receiving status of the relay station and the feedback status of the terminal. “Bitmap 2” field is used to indicate the receiving status of the relay station receiving the HARQ data block which corresponds to NAK bits in the bitmap 1.

The message format, illustrated in FIG. 8, includes, but is not limited to, the above items. For instance, a field for indicating the total length of the message may be added. Furthermore, the representation of the bitmap is not so limited. Any representation that may identify the receiving status of the data block may be contemplated.

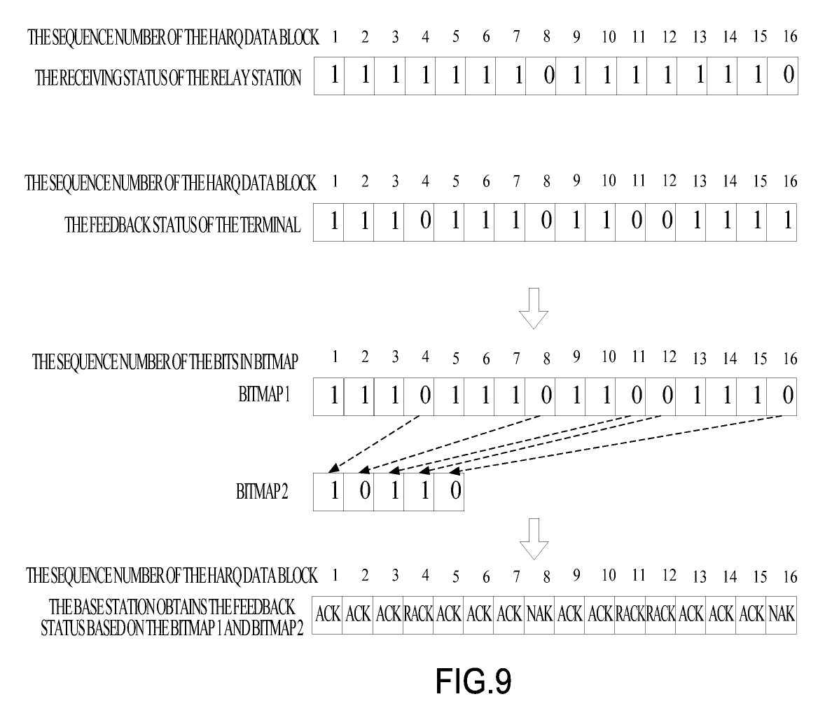

Examples are given below for illustration of the encoding schemes for bitmap 1 and bitmap 2. As illustrated in FIG. 9, binary “1” represents a correct receiving status, and binary “0” represents an incorrect receiving status. The receiving status of the relay station indicates that the 8th and 16th HARQ data blocks the relay station receives from the base station are in error. The feedback status of the terminal indicates that the 4th, 8th, 11th, and 12th HARQ data blocks are not received correctly. Then, the relay station performs a bitwise “AND” operation based on these two status tables and, thus, bitmap 1=(1110111011001110)2 is derived, where “( )2” indicates the binary expression. In another embodiment of the present invention, if binary “0” is used to represent a correct receiving status and binary “1” is used to represent an incorrect receiving status, then “OR” operation is performed. Bitmap 2 represents the receiving status of the relay station regarding the data blocks associated with the “0” bits in bitmap 1. In bitmap 1, the “0” bits are the 4th, 8th, 11th, 12th, and 16th bits. Accordingly, bitmap 2=(10110)2 is derived according to the receiving status of the relay station regarding the HARQ data block associated with these “0” bits. For the 16th HARQ data block, although the result of the decoding of the feedback information performed by the relay station is ACK, the relay station itself has not correctly received the data block, the relay station deems the decoding for the feedback message from the terminal as unreliable. It still feeds back a NAK status of the HARQ data block when reporting to the base station. After the base station receives a feedback message of the status of the HARQ data block from the relay station, the base station determines the transmission status of each HARQ data block based on the bitmap 1 and bitmap 2 fields in the feedback message.

At Step 108, the relay station encapsulates the bitmaps in a message, for example, illustrated in FIG. 8, and transmits the message to the base station.

At Step 109, the base station decodes the message and determines whether status of an HARQ data block is ACK. If it is an ACK, it is indicated that the data block has been transmitted correctly to the terminal. The base station then terminates the processing of the data block. Otherwise, Step 110 is performed.

At Step 110, the base station determines whether status of the data block is a NAK. If it is a NAK, it is indicated that an error occurs during the process of transmitting the data block from the base station to the relay station, and Step 111 is performed. Otherwise, it is indicated that the data block is transmitted correctly from the base station to the relay station but an error occurs during the transmission from the relay station to the terminal, and Steps 112-113 are then performed.

At Step 111, the base station generates the data block to be retransmitted and retransmits the generated data block.

At Step 112, the base station allocates time and frequency resource to the terminal. The time and frequency resource is used by the relay station for retransmitting the data block to the terminal. Parameters for the retransmitted data block may be provided when allocating the time and frequency resources. The parameters may include HARQ type, sequence number, and modulation scheme of the retransmitted data block.

At Step 113, the relay station transmits the retransmitted data block to the terminal via the downlink terminal sub-frame in the time and frequency resource that the base station allocates to the terminal. There are two approaches for the base station to allocate time and frequency resources to the relay station. One is that the base station allocates the resources to the relay station after the base station determines that the data block has been received correctly by the relay station, according to the receiving status message. The other is that the base station reserves time and frequency resources for the relay station before the base station receives the receiving status message.

In the foregoing procedure, for the frame structure illustrated in FIG. 5, the terminal may directly receive the information of time and frequency resource allocation transmitted by the base station. Therefore, the relay station in this case may not relay the terminal frame header. For the frame structure illustrated in FIG. 6, the base station and the relay station may transmit the same terminal frame header simultaneously. The terminal frame header to be transmitted by the relay station is provided by the base station in a previous relay downlink sub-frame. Because the step transmitting the terminal frame header by the base station is performed only in the case of the frame structure illustrated in FIG. 6, the step is not described in the foregoing procedure. However, this does not mean that this step can be omitted in the case of the frame structure illustrated in FIG. 6.

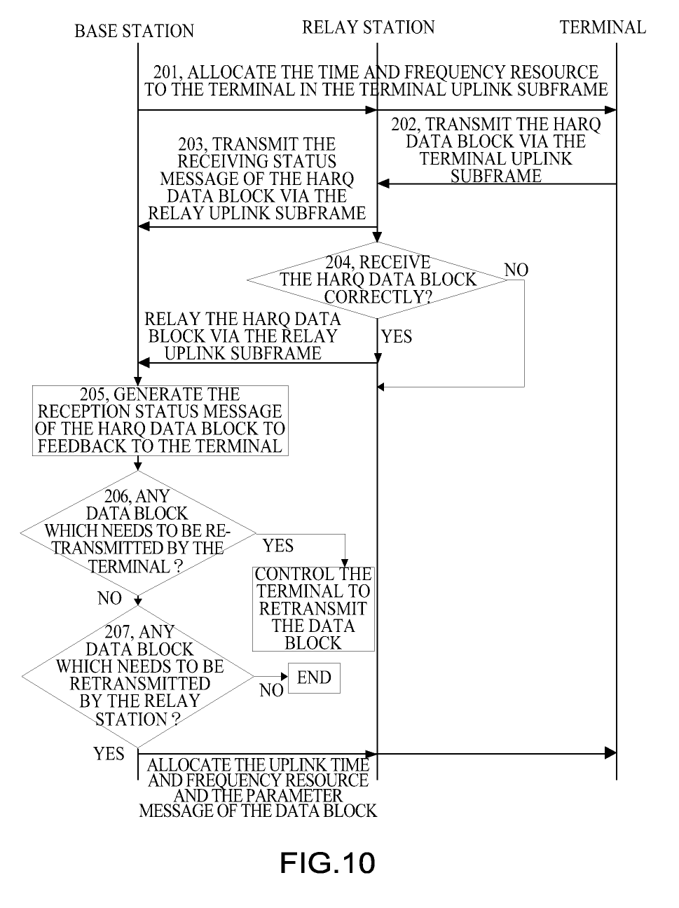

FIG. 10 is a flowchart of a method for relaying uplink HARQ data block through a relay station according to one embodiment of the present invention. The method may include the following steps.

At Step 201, the base station allocates an uplink time and frequency resource for the terminal in the terminal frame header. The uplink time and frequency resource is used for transmitting HARQ data block by the terminal. The base station may inform the terminal of parameters regarding the HARQ data block. The parameter may include the HARQ type, the sequence number and the modulation scheme of the data block. For the frame structure illustrated in FIG. 6, the base station and relay station may transmit simultaneously the time and frequency resource allocation message and HARQ data block parameter message.

At Step 202, according to the parameters of the data block, the terminal transmits HARQ data block via the terminal uplink sub-frame in the time and frequency resource allocated by the base station.

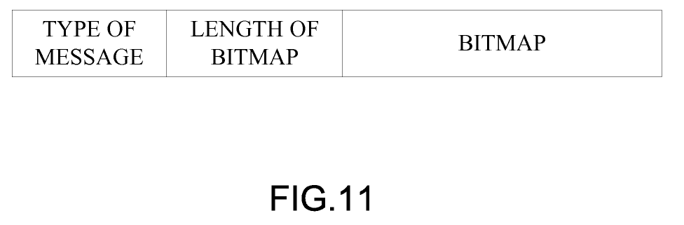

At Step 203, after receiving the HARQ data block transmitted from the terminal, the relay station informs the base station of receiving status information of the relay station by sending a receiving status message of the relay station. FIG. 11 illustrates one example of the message format. The message may include all the receiving statuses of the uplink HARQ data blocks received by the relay station at the same frame. The message type field identifies the message as an uplink HARQ receiving status message. The bitmap length field indicates the length of the bitmap field. The length could be represented in the unit of byte or bit. The k^{th} bit in the bitmap field indicates the receiving status of the k^{th} HARQ data block received by the relay station. Binary “0” may be used to indicate receiving incorrectly (NAK), the binary “1” may be used to indicate receiving correctly (ACK). Alternatively, the binary “1” may be used to indicate receiving incorrectly (NAK) and the binary “0” may be used to indicate receiving correctly (ACK).

At Step 204, if the relay station receives the HARQ data block correctly from the terminal, the relay station may relay the HARQ data block to the base station in an uplink time and frequency resource allocated by base station. Otherwise, the relay station may not transmit the data block.

At Step 205, the base station generates a receiving status message of the uplink HARQ data block to be transmitted to the terminal, according to the receiving status message of the relay station transmitted from the relay station. Then, the base station transmits the generated receiving status message to the terminal. The content of the generated receiving status message may substantially be the same as the content of the receiving status message of the relay station transmitted from the relay station. The message structures of the two messages may be similar or different. The reason behind this is that the protocols of the transmitting side and the receiving side may be similar or different in these two cases. The transmission scheme for the receiving status message to be transmitted to the terminal depends on the specific system. The receiving status message to be transmitted to the terminal may be transmitted on a dedicated HARQ feedback channel. Alternatively, all the feedback information regarding the uplink HARQ data blocks may be aggregated in one message using a broadcast message which may be transmitted in the form of bitmap. Each bit of the bitmap corresponds to an associated receiving status of the HARQ data block.

At Step 206, the base station determines whether there exists any HARQ data block which needs to be retransmitted by the terminal, according to the received receiving status message of the relay station. If there exists any HARQ data block which needs to be retransmitted by the terminal, the base station controls the terminal to retransmit the data block; if not, Step 207 is performed.

In this step, the terminal receives the receiving status message of the relay station. If acknowledge (ACK) information is received, it is believed that the data block has arrived correctly at the receiving side. If non-acknowledge (NAK) information is received, it is believed that the data block has not arrived at the receiving side correctly. Virtually, according to the embodiment of the present invention, even the terminal receives the acknowledge information, it only means that the transmitted data has arrived correctly at the relay station. It is uncertain that the data has been relayed correctly to the base station. If the data has not been relayed correctly to the base station, the data relayed incorrectly needs to be retransmitted by virtue of the negotiation between the base station and the relay station. The terminal is completely unaware of the data transmission status between the base station and the relay station. The purpose of doing so is to ensure the transparency of the relay station for the terminal.

At Step 207, the base station determines whether there exists any HARQ data block which needs to be retransmitted by the relay station, according to receiving status of the base station. If so, the base station allocates an uplink time and frequency resource for the relay station and transmits a parameter message regarding the HARQ data block to be retransmitted to the relay station, for the purpose of the retransmission of the HARQ data block by the relay station. Otherwise, the procedure ends.

In the above procedure, Step 203 and Step 204 may be performed with no specific time order. The relay station may also first relay the data and then transmit the receiving status message of the relay station receiving the uplink HARQ data block to the base station in other embodiments of the present invention.

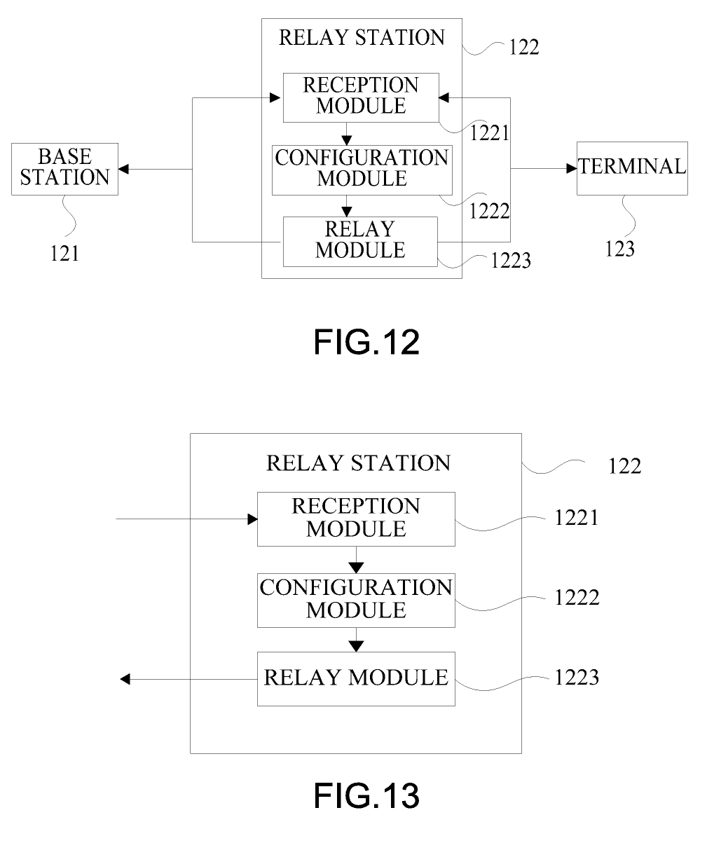

FIG. 12 is a diagram of a system for implementing HARQ, according to one embodiment of the present invention. The system includes a base station 121, a relay station 122 and a terminal 123.

The base station 121 is adapted to transmit and receive data blocks through the relay station 122 and determine whether retransmission of the data block is needed, according to a receiving status of the data block returned from the relay station 122. In one embodiment of the present invention, a bitmap scheme is used to represent the receiving status of the data block, i.e. whether the data block transmitted by the base station 121 has been received correctly by the terminal 123. If the data block has not been received correctly, the base station 121 may further determine whether it is the relay station 122 that has not received the data block correctly or the terminal 123 that has not received the data block correctly. As such, the base station 121 can determine whether the data block should be retransmitted by the relay station 122 or by the base station 121.

The relay station 122 is adapted to receive and relay the data block of the base station 121 or the terminal 123 and return the receiving status of the data block to the transmitting side.

The terminal 123 is adapted to transmit data block to the base station 121/or receive data block from the base station 121 through the relay station 122. The terminal 123 may be further adapted to determine whether retransmission of the data block is needed, based on the receiving status of the data block returned from the relay station 122. Likewise, a bitmap scheme is used to represent the receiving status of the data block, i.e. whether the data block transmitted by the terminal 123 has been received correctly by the base station 121. If the data block has not been received correctly, the terminal 123 determines whether it is the relay station 122 that has not received the data block correctly or the base station that has not received the data block correctly. As such, it can be determined whether the data block should be retransmitted by the relay station or by the terminal itself

Further, the base station 121 and the terminal 123 may be further adapted to decode and verify the data block relayed by the relay station 122. With the verification result, feedback information may be transmitted to the relay station 122. The feedback information indicates whether the data block has passed the verification.

Further, the relay station 122 may be further adapted to set receiving status for the data block, according to the feedback information and status information of receiving the data block by the relay station 122. For different transmission directions, there are three types of receiving statuses, respectively: the data block has been received correctly by the terminal 123, the data block has not been received correctly by the relay station 122, and the data block has been received correctly by the relay station 122, but not received correctly by the terminal 123; the data block has been received correctly by the base station 121, the data block has not been received correctly by the relay station 122, and the data block has been received correctly by the relay station 122, but not received correctly by the base station 121.

The relay station 122 may be adapted to set the receiving status of the data block by two bitmaps.

One example of the relay station 122 is illustrated in FIG. 13. The relay station 122 may includes a reception module 1221, a configuration module 1222, and a relay module 1223.

The reception module 1221 is adapted to receive data block from a base station or a terminal.

The configuration module 1222 is adapted to set the receiving status of the data block and determine whether the data block has been received correctly, according to the feedback information returned by the terminal or the base station receiving the data block. The configuration module 1222 may further be adapted to use two bitmaps to represent the receiving status of the data block. The first bitmap indicates whether the data block has been received correctly by the receiving side. The second bitmap indicates whether it is the relay station or the receiving side that has not received the data correctly given the situation that the data block has not been received correctly by the receiving side.

The relay module 1223 is adapted to relay the data block to the terminal or base station and transmit the receiving status of the data block to the base station or the terminal which transmits the data block.

According to the embodiments of the present invention, the present invention allowing the relay system to support HARQ transmission and the system performance is enhanced without changing the existing terminal, thereby providing compatibility for the conventional terminal.

Embodiments within the scope of the present invention also include computer-readable media for carrying or having computer-executable code, computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

At last, it should be noted that the foregoing embodiments are merely illustrations for the technical solutions of the present invention, as the invention is not so limited. Although some embodiments are provided for illustration, it is appreciated by a person of ordinary skill in the art that any modifications or equivalents may be made to the technical solutions of the present invention without departing from the spirit and scope of the technical solutions of the present invention.

What is claimed is:

1. A method for implementing hybrid automatic retransmission, comprising:
transmitting, by a base station, a data block to be transmitted to a terminal to a relay station via a relay downlink sub-frame, wherein the relay station serves the terminal;
relaying, by the relay station, the data block to the terminal via a terminal downlink sub-frame in a time and frequency resource allocated to the terminal by the base station, after the relay station receives the data block;
decoding and verifying, by the terminal, the received data block, and transmitting feedback information in a hybrid automatic retransmission feedback sub-channel, based on the result of the verification;
transmitting, by the relay station, new feedback information to the base station according to the feedback information transmitted from the terminal and status information of the relay station receiving the data block from the base station; and
decoding, by the base station, the new feedback information and controlling retransmission procedure, according to the new feedback information.

2. The method of claim 1, wherein the step of relaying the data block to the terminal comprises:
allocating, by the base station, the time and frequency resource to the terminal in a terminal frame header, and informing the terminal of parameters of the data block, wherein the parameters comprises the type of the hybrid automatic retransmission, the sequence number, and the modulation scheme of the data block;
determining, by the relay station, whether the data block has been received and demodulated correctly; if the data block has been received and demodulated correctly, transmitting the data block to the terminal in the time and frequency resource allocated to the terminal; otherwise, not transmitting the data block to the terminal; and
decoding, by the terminal, the terminal frame header and receiving the data block in the time and frequency resource allocated to the terminal.

3. The method of claim 1, wherein the step of decoding, verifying the received data block and transmitting feedback information comprises:
decoding and verifying, by the terminal, the received data block, and determining whether the data block has passed the verification; if the data block has passed the verification, returning ACK information in the hybrid automatic retransmission feedback sub-channel; otherwise, returning NAK information.

4. The method of claim 1, wherein the step of transmitting new feedback information to the base station comprises:
setting, by the relay station, the receiving status of the data block, according to the feedback information transmitted from the terminal, and the status information of the relay station receiving the data block from the base station;
encoding the receiving status of the data block, wherein the encoded receiving status indicates different receiving statuses of the data block; and
transmitting the encoded receiving status to the base station.

5. The method of claim 4, wherein the step of encoding the receiving status of the data block comprises:
setting, by the relay station, two bitmaps, wherein the first bitmap records the receiving status of the terminal receiving the data block, and the second bitmap records the receiving status of the relay station receiving the data block.

6. The method of claim 4, wherein the relay station sets three types of receiving statuses of the data block, wherein the receiving statuses comprises: the data block has been correctly received by the terminal, the data block has not been received correctly by the relay station, and the data block has been received correctly by the relay station, but not received correctly by the terminal;
wherein the step of decoding the terminal frame header and receiving the data block comprises:
(e1) decoding, by the base station, the new feedback information; and determining whether the data block has been received correctly by the terminal; if the data block has been received correctly by the terminal, terminating the processing of the data block; otherwise, performing Step (e2);
(e2) determining whether the data block has been received correctly by the relay station; if the data block has been received correctly by the relay station, performing Steps (e4)-(e5); otherwise, performing Step (e3);
(e3) generating, by the base station, the data block to be retransmitted to the relay station, and retransmitting the generated data block;
(e4) allocating, by the base station, the time and frequency resource to the terminal, wherein the time and frequency resource is used by the relay station for transmitting the data block to be retransmitted to the terminal; providing parameters of the data block to be retransmitted when allocating the time and frequency resource, wherein the parameters comprise the type of hybrid automatic retransmission request, the sequence number and the modulation scheme of the data block to be retransmitted; and
(e5) transmitting, by the relay station, the data block to be retransmitted to the terminal via a downlink terminal sub-frame in the time and frequency resource allocated to the terminal.

7. A method for implementing hybrid automatic retransmission, comprising:
receiving, by a relay station, a data block transmitted in an uplink time and frequency resource allocated to a terminal by a base station, from the terminal;
transmitting, by the relay station, a receiving status message of the relay station indicating whether the data block is correctly received by the relay station, to the base station;
transmitting, by the base station, the content of the receiving status message of the relay station to the terminal; and
controlling, by the base station, the terminal or the relay station to retransmit the data block according to the receiving status message of the relay station.

8. The method of claim 8, wherein the parameter message comprises the HARQ type, the sequence number and the modulation scheme of the data block.

9. The method of claim 7, further comprising:
relaying, by the relay station, the data block to the base station in an uplink time and frequency resource allocated to the relay station by the base station, if the relay station receives the data block correctly.

10. The method of claim 9, wherein the uplink time and frequency resource is allocated by the base station to the relay station after the base station determines that the data block is received by the relay station correctly, based on the receiving status message of the relay station; or
the uplink time and frequency resource is reserved by the base station for the relay station before the base station receives the receiving status message.

11. The method of claim 7, wherein the step of controlling the terminal to retransmit the data block comprises:
controlling, by the base station, the terminal to retransmit the data block if the base station determines the data block is received by the relay station incorrectly, according to the receiving status message of the relay station.

12. The method of claim 7, wherein the step of controlling relay station to retransmit the data block comprises:
controlling, by the base station, the relay station to retransmit the data block, if the base station determines the data block is received by the relay station correctly, according to the receiving status message of the relay station, but is received by the base station incorrectly.

13. A system for implementing hybrid automatic retransmission, comprising:
a relay station and a base station, wherein:
the relay station is configured to receive a data block transmitted from a terminal and send receiving status information of the relay station to the base station, wherein the receiving status information of the relay station indicates whether the relay station receives the data block correctly; and
the base station is configured to determine whether the data block needs to be retransmitted according to the status information of the relay station receiving the data block.

14. The system of claim 13, wherein:
the relay station is further adapted to relay the data block to the base station, if the relay station receives the data block from the terminal correctly.

15. The system of claim 13, wherein:
the relay station is further adapted to send an ACK to the base station, if the relay station receives the data block correctly; or adapted to send a NAK to the base station, if the relay station receives the data block incorrectly.

16. The system of claim 13, wherein:
the base station is further configured to control the relay station to retransmit the data block if the base station determines that the data block is received by the relay station correctly, according to the receiving status information of the relay station, but is received by the base station incorrectly.

17. The system of claim 13, wherein:
the base station is further configured to control the terminal to retransmit the data block to the base station through the relay station, if the base station determines the data block is received by the relay station incorrectly, according to the receiving status information of the relay.

18. A relay station for implementing hybrid automatic retransmission, comprising:
means for receiving, from a terminal, a data block in an uplink time and frequency resource allocated to a terminal by a base station;
means for sending receiving status information of the relay station to the base station, wherein the receiving status information of the relay station indicates whether the relay station receives the data block correctly; and
means for retransmitting the data block to the base station, if the base station determines that the data block is received by the relay station correctly, according to the receiving status information of the relay station, but is received by the base station incorrectly.

19. The relay station of claim 18, further comprising:
means for relaying the data block received from the terminal to the base station, if the relay station receives the data block correctly.

20. The relay station of claim 18, wherein the means for sending the receiving status information of the relay station comprises means for sending an ACK to the base station, if the relay station receives the data block correctly; or means for sending a NAK to the base station, if the relay station receives the data block incorrectly.
